(19) United States
(12) Patent Application Publication
(10) Pub. No.: US 2005/0198545 A1
(43) Pub. Date: Sep. 8, 2005

(54) Automatic user device presence registration system

(75) Inventors: Kyoko Takeda Wieck, San Diego, CA (US); Theodore R. Booth III, San Diego, CA (US); Jason Lee Clement, San Diego, CA (US)

Correspondence Address: ROGITZ & ASSOCIATES;Suite 3120, 750 B Street, San Diego, CA, 92101, US

(73) Assignees: Sony Corporation; Sony Electronics Inc.

(21) Appl. No.: 10/872,993

(22) Filed: Jun. 21, 2004

Related U.S. Application Data
(60) Provisional application No. 60/544,602, filed on Feb. 12, 2004.

(51) Int. Cl. G06F 1/30; G06F 12/14; G06F 15/173

(52) U.S. Cl. 713/323; 709/224

(57) ABSTRACT

A user device automatically sends a presence message to a presence server when the user device is powered on. Thereafter, the user device may send a sleep message to the presence server upon power down or prolonged period of inactivity, or the device may be required to send periodic messages to the presence server to maintain it as being listed as an active device. The presence server is then used to manage communication with the user device based on the presence information.

### RELATED APPLICATIONS

This application claims priority from U.S. provisional application Ser. No. 60/544,602, filed Feb. 12, 2004.

### FIELD OF THE INVENTION

The present invention relates generally to Internet communications that are managed by presence servers.

### BACKGROUND

To send a message to a recipient, the message must be addressed to the recipient using the protocol of a particular communication or messaging system. For example, email messages require a SMTP, IMAP, or POP address. As part of sending a message, the sender must decide which messaging service is best suited to deliver the message, including determining which service will recognize the recipient. This can require that the recipient be available on the service.

Accordingly, in determining accessibility it is often necessary to have reliable presence information relating to intended recipients. In some systems such as instant messaging systems, presence information is maintained once the user logs onto the service. However, this requires the user to invoke the instant messaging application, which the user might forget to do. Moreover, once logged on, the system has no way of determining whether the user is actually observing the user device terminal and, hence, has no way of knowing whether the user, as opposed to the user device, is actually present unless the user logs off or otherwise indicates that he or she is away. With this in mind, the inventions herein are provided.

### SUMMARY OF THE INVENTION

A system for managing communication with a user device includes a presence server that receives a message which is automatically generated and transmitted by a user device when the user device has been powered down, and/or when the user device has not been operated for a predetermined period, and/or when the user device receives a power on message. Also, the presence server may receive another type of message that is automatically generated and transmitted by a user device which indicates the user device should remain indicated as being active. The presence server uses the messages to maintain data indicating user devices available for communication.

In another aspect, a user device includes means for registering with a presence server, and means for generating, without user intervention, a message to the presence server indicating that the user device has been inactive for a period longer than a threshold. In addition or alternatively, the user device can generate a message to the presence server indicating that the user device remains available for communication. With this invention, the presence server can indicate the user device as being available for communication.

In yet another aspect, a presence server maintains data indicating what devices are active based on user device messages indicating no activity at the user device for a period at least a great as a threshold, and/or based on user device messages indicating continuing desire to remain designated an active device.

In still another aspect, a method for advertising over the Internet includes accessing information in a presence server indicating active user devices. The method also includes, based on the information, transmitting, over the Internet, at least one advertisement to the active user devices.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system;

FIG. 2 is a flow chart showing the set up process;

FIG. 3 is a flow chart showing the subsequent log on process;

FIG. 4 is a flow chart showing the automatic sleep message process;

FIG. 5 is a flow chart showing the automatic keep alive process; and

FIG. 6 is a flow chart showing a method for advertising using the presence server.

### DETAILED DESCRIPTION OF THE PREFERRED EMBODIMENT

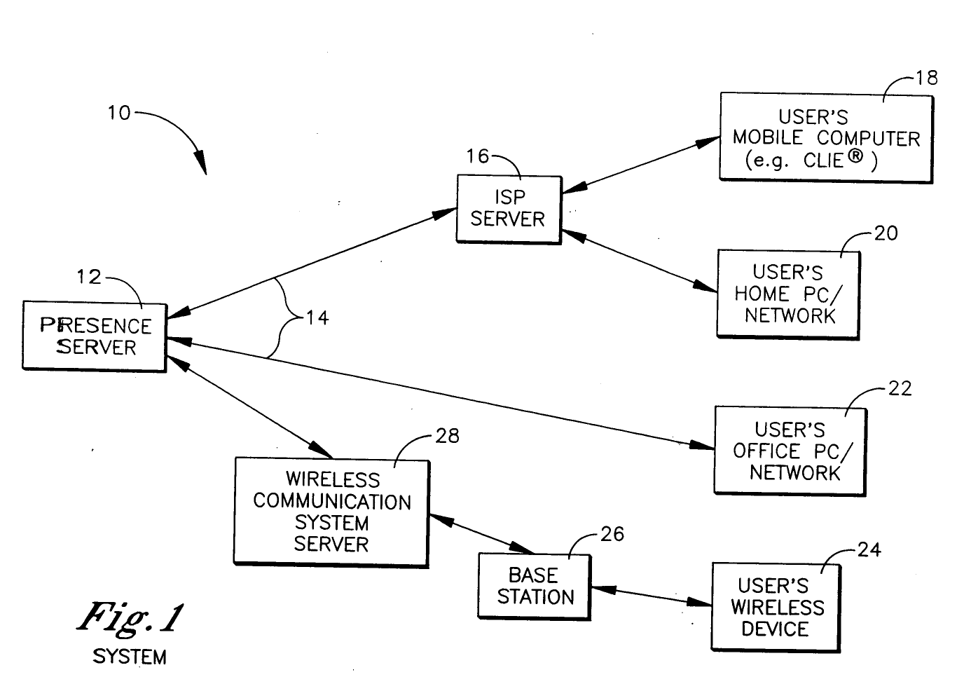

Referring initially to FIG. 1, a system is shown, generally designated 10, that includes a presence server 12. The presence server 12 may be any appropriate Internet-capable server computer, and it may be owned by or associated with a particular organization. Without limitation, the presence server may be an instant messaging server.

As shown in FIG. 1, the presence server 12 can communicate, over the Internet 14, with Internet Service Provider (ISP) servers/networks 16 (only a single ISP server 16 shown for clarity). The ISP server/network 16 in turn provides a gateway to the Internet 14, including to the presence server 12, in accordance with principles known in the art for a user's various computing devices (only the devices of a single user shown for illustration). Specifically, a user can communicate with the ISP server 16 using a mobile computer 18 such as a Sony Clie® and a home PC, laptop, or home network computing system 20 (shown as two blocks in FIG. 1 to indicate that a standalone PC 20 can communicate directly with the ISP server 16 or through a home network). The computing devices 18, 20 communicate using software such as browsers and hardware such as, e.g., modems, or wireless communication systems, or other means known in the art. Also, the user might access the presence server 12 using his or her office computer/computer network system 22 (likewise shown as two blocks in FIG. 1 to indicate both the office PC and the office network). As well, the mobile device 18 might include wireless communication capability, such as a mobile telephone chip or system, that communicates with various base stations 26 in a wireless communication system and thus with an Internet-accessing wireless communication system server/network 28. As shown, the wireless communication system server 28 communicates with the presence server 12 using the Internet. Still further, the mobile device 18 might possess capabilities such as wi-fi to communicate with the presence server 12 through the Internet 14 and a local relay station 29, colloquially referred to as a “hot spot”.

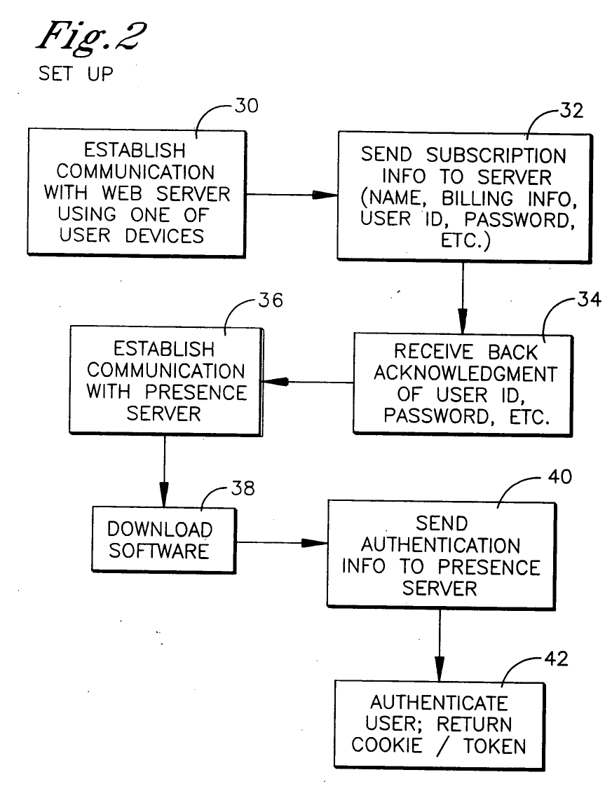

FIG. 2 shows how a user can set up one or more of the user devices to cooperate with the presence server 12 to implement the present invention. Commencing at block 30, communication is established between, e.g., the home PC 20 and the ISP server 16. Then, at block 32 subscription information such as the user's name, billing information, user ID, and password are sent to the server. Block 34 indicates that the server may respond with an acknowledgement of the user ID and password.

At block 36, communication is established between the user device and the presence server 12, which accesses the registration information sent at block 32. That is, the initial registration information exchange can be between the ISP server 16 and user device, or it can be direct between the user device and the presence server 12.

In any case, at block 38 application software for executing the service associated with the presence server 12 is downloaded to the user device. Authentication information can be sent to the presence server 12 at block 40 in accordance with Internet authentication principles known in the art. The user is authenticated at block 42 and as part of the authentication process a cookie or other token may be returned to the user device. Each user device in turn can be registered by sending authentication information from the device to the presence server and receiving back a token for that device.

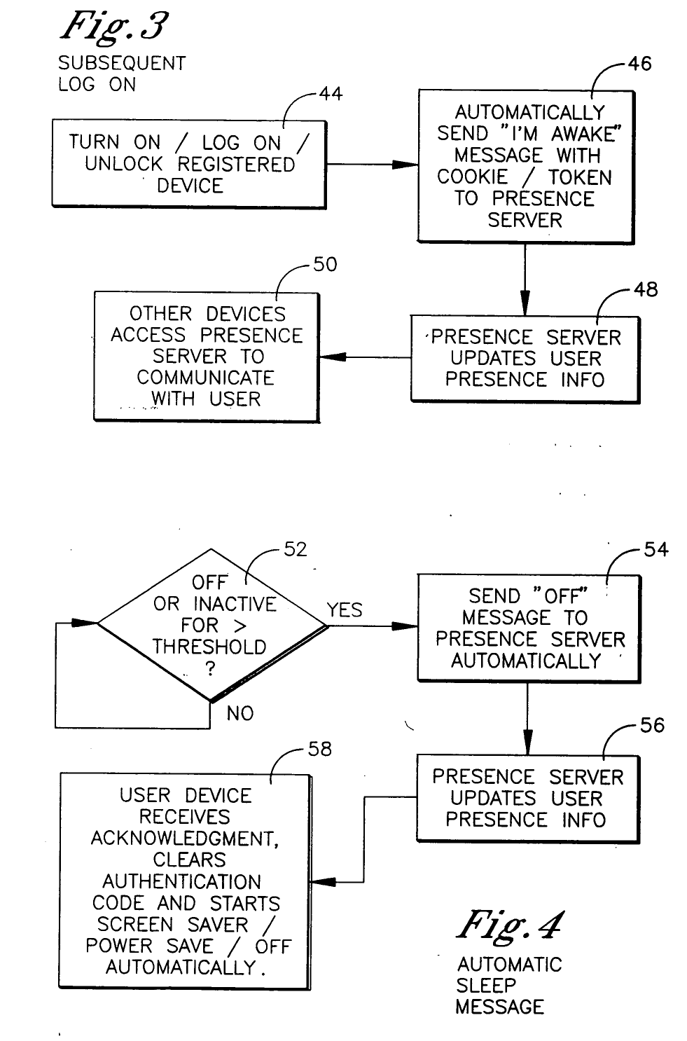

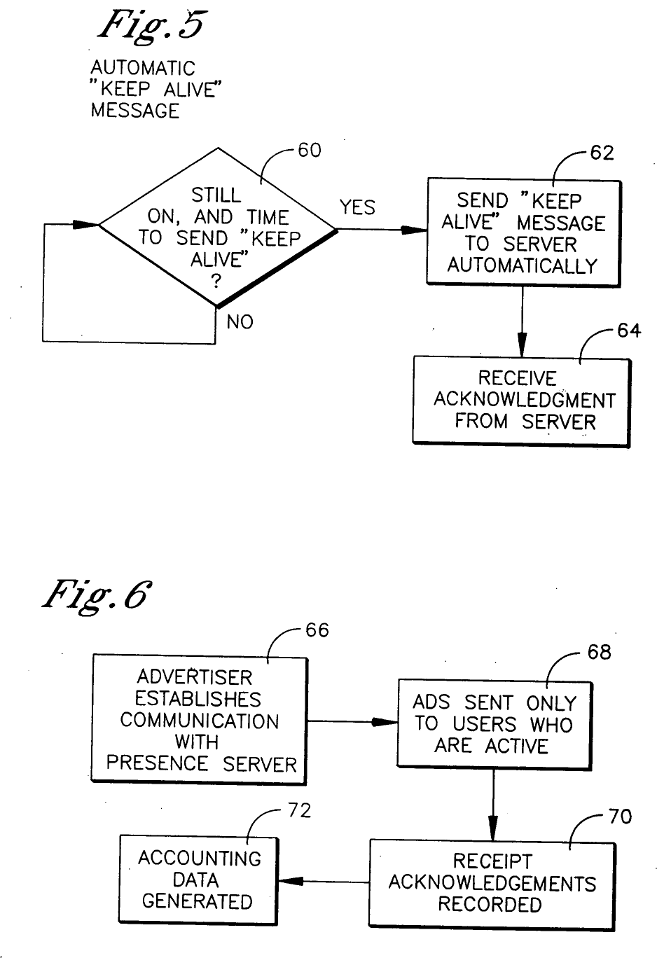

FIG. 3 shows the non-limiting process that can be followed after registration. Commencing at block 44, one of the user devices is turned on, or logged onto the Internet, or unlocked. Automatically, at block 46 the user device sends a message to the presence server 12 indicating that the device is present and available for communication. The message can be sent with the device's token if desired. At block 48 the presence server updates a data structure such as a list, table, or other structure of active devices to reflect the presence of the user device. The presence server 12 may alert other active devices that the user device has just become available for communication. Block 50 indicates that the other devices may address messages to the user device which, owing to its being included in the data structure of the presence server 12, receives messages through the presence server 12.

The present invention recognizes that once a user device is reflected as being present, the user of the device may, at some point, stop using the device without logging off or otherwise indicating that the user himself or herself is no longer monitoring the device. Accordingly, FIG. 4 shows that when it is determined at decision diamond 52 that an active user device has been inactive for longer than a threshold period or that a user has entered a “deenergize” command, an “inactive” or “off” message can be automatically (without user intervention or interaction) sent by the user device to the presence server at block 54 so indicating. Inactivity can be indicated by, e.g., a lack of an input from a keyboard or mouse for longer than the threshold period, and can be determined by the user device itself. At block 56 the data structure of active user devices is updated by the presence server 12, and then at block 58 the presence server 12 can send an acknowledgement to the user device that the user device is no longer active. The user device and/or presence server may clear authentication codes, and the user device can enter a power save mode, screen saver mode, or can even deenergize itself (particularly if battery-powered) automatically.

In contrast, when, for instance, the user device is a mobile computing device, it may be desirable to automatically remove the device from the data structure of active devices unless messages are periodically received from the device. Accordingly, referring now to FIG. 5, if a user device that is active with the presence server 12 determines at decision diamond 60 that the user has not input a command to deactivate, the logic moves to block 62 to automatically (without user intervention) send a message to the presence server 12 indicating that the user device should remain indicated as being active. An acknowledgement of receiving the message and continuing the active status of the user device may be sent by the presence server 12 to the user device at block 64. It is to be understood that for a user device employing the logic of FIG. 5, failure on the part of the presence server 12 to receive a message from the user device after the elapse of a predetermined time period will cause the presence server 12 to remove the user device from the data structure of active devices.

FIG. 6 shows an exemplary application afforded by the presence server 12 system described above. At block 66 an advertiser, by means of an advertising Web server (not shown), can communicate with the presence server to access information in the presence server indicating active user devices. Then, at block 68, based on the information, advertisements can be transmitted over the Internet only to the active user devices. The advertisements can be sent from the presence server 12 if desired, or the presence server 12 can provide active user information to the advertiser who can send the advertisements directly to user devices. If desired, active user devices receiving advertisements may acknowledge receipt at block 70, with accounting data being generated at block 72.

The accounting data is based on the advertisements. In one non-limiting embodiment, accounting data is generated only for advertisements sent to users who return acknowledgements of receipt of the advertisement. Or, accounting data can be generated for advertisements sent to active user devices regardless of acknowledgements of receipt. If desired, a user device service charge can be reduced for users agreeing to accept advertisements.

While the particular AUTOMATIC USER DEVICE PRESENCE REGISTRATION SYSTEM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

1. A system for managing communication with at least one user device, comprising:
at least one presence server receiving at least one of: a first message automatically generated and transmitted by a user device when the user device receives a power down command, and/or when the user device has not been operated for a predetermined period, and/or when a user device receives a power on message, and a second message automatically generated and transmitted by a user device indicating the user device should remain indicated as being active, the presence server using the messages to maintain data indicating user devices available for communication.

2. The system of claim 1, comprising plural user devices, at least a first user device automatically transmitting to the presence server at least one first message.

3. The system of claim 1, comprising plural user devices, at least first user device automatically transmitting to the presence server at least one second message.

4. The system of claim 3, wherein the first user device is a mobile computing device.

5. The system of claim 1, comprising plural user devices communicating with each other using the data in the presence server.

6. A user device comprising:
means for registering with a presence server;
at least one means selected from the group consisting of:
means for generating, without user intervention, a message to the presence server indicating that the user device has been inactive for a period longer than a threshold, whereby the presence server can indicate the user device as being available for communication; and
means for generating, without user intervention and after having been authenticated with the presence server, a message to the presence server indicating that the user device remains available for communication, whereby the presence server can indicate the user device as remaining available for communication.

7. The user device of claim 6, comprising means for generating, without user intervention, a message to the presence server indicating that the user device has been inactive for a period longer than a threshold, whereby the presence server can indicate the user device as being available for communication.

8. The user device of claim 6, comprising means for generating, without user intervention and after having been authenticated with the presence server, a message to the presence server indicating that the user device remains available for communication, whereby the presence server can indicate the user device as remaining available for communication.

9. The user device of claim 8, wherein the user device is a mobile computing device.

10. The user device of claim 6, comprising means for communicating with other user devices using the data in the presence server.

11. A user computing device comprising logic embodying method acts including:
generating, without user intervention, a message to a presence server indicating that the user device has been inactive for a period longer than a threshold, whereby the presence server can indicate the user device as being available for communication.

12. A user computing device comprising logic embodying method acts including:
generating, without user intervention and while being indicated as being an active device by a presence server, a message to the presence server indicating that the user device remains available for communication, whereby the presence server can continue to indicate the user device as remaining available for communication.

13. A presence server, comprising logic for undertaking method acts comprising:
maintaining data indicating what devices are active based at least in part on at least one of: user device messages indicating no activity at the user device for a period at least a great as a threshold, and user device messages indicating continuing desire to remain designated an active device.

14. The presence server of claim 13, wherein the presence server is accessible over the Internet.

15. The presence server of claim 13, wherein the logic includes maintaining data indicating what registered devices are active based at least in part on user device messages indicating no activity at the user device for a period at least a great as a threshold.

16. The presence server of claim 13, wherein the logic includes maintaining data indicating what registered devices are active based at least in part on user device messages indicating continuing desire to remain designated an active device.

17. The presence server of claim 13, wherein the presence server maintains a data structure indicating only active user devices based on the user device messages.

18. A method for advertising over the Internet, comprising:
accessing information in a presence server indicating active user devices; and
based on the information, transmitting, over the Internet, at least one advertisement to the active user devices.

19. The method of claim 18, comprising generating accounting data based on the advertisement.

20. The method of claim 18, comprising generating accounting data based on acknowledgements of receipt of the advertisement from user devices.

21. The method of claim 18, comprising establishing a user device service charge based at least in part on a user agreeing to receive advertisements.
